(19) United States
(12) Patent Application Publication
(10) Pub. No.: US 2012/0092351 A1
(43) Pub. Date: Apr. 19, 2012

(54) FACILITATING ATOMIC SWITCHING OF GRAPHICS-PROCESSING UNITS

(75) Inventor: Andrew R. Barnes, Foster City, CA (US)

(73) Assignee: APPLE INC., Cupertino, CA (US)

(21) Appl. No.: 12/959,051

(22) Filed: Dec. 2, 2010

Related U.S. Application Data
(60) Provisional application No. 61/394,674, filed on Oct. 19, 2010.

(51) Int. Cl. G06F 15/80

(52) U.S. Cl. 345/505

(57) ABSTRACT

The disclosed embodiments provide a system that configures a computer system to switch between two graphics-processing units (GPUs). During operation, the system receives a request to switch from using a first GPU to using a second GPU to drive the display. In response to this request, the system executes a user thread that copies pixel values from a first framebuffer for the first GPU to a second framebuffer for the second GPU. Next, the user thread initiates a switch from the first framebuffer to the second framebuffer as a signal source for driving the display. Finally, the user thread sends an asynchronous notification of the switch to one or more applications, wherein the asynchronous notification allows the applications to transition from rendering graphics using the first GPU to rendering graphics using the second GPU.

### RELATED APPLICATION

This application hereby claims priority under 35 U.S.C. §119 to U.S. Provisional Application No. 61/394,674, entitled “Facilitating Atomic Switching of Graphics-Processing Units,” by Andrew R. Barnes, filed 19 Oct. 2010 (Atty. Docket No.: APL-P10014USP1).

### BACKGROUND

1. Field

The disclosed embodiments relate to techniques for switching between graphics-processing units (GPUs) in a computer system. More specifically, the disclosed embodiments relate to techniques for atomic switching between GPUs in a computer system.

2. Related Art

Computer systems are beginning to incorporate high-resolution, high-power graphics technology. Rapid developments in this area have led to significant advances in 2D and 3D graphics technology, providing users with increasingly sophisticated visual experiences in domains ranging from graphical user interfaces to realistic gaming environments. Underlying many of these improvements is the development of dedicated graphics-rendering devices, or graphics-processing units (GPUs). A typical GPU includes a highly parallel structure that efficiently manipulates graphical objects by rapidly performing a series of primitive operations and displaying the resulting images on graphical displays.

Unfortunately, there are costs associated with these increased graphics capabilities. In particular, an increase in graphics performance is typically accompanied by a corresponding increase in power consumption. Consequently, many computer systems and portable electronic devices may devote a significant amount of their power to support high-performance GPUs, which may cause heat dissipation problems and decrease battery life.

One solution to this problem is to save power during low-activity periods by switching between a high-power GPU that provides higher performance and a low-power GPU with better power consumption. However, switching between two GPUs may involve significant overhead and/or synchronization. For example, a GPU switch may be implemented as an unplugging of a first display associated with a first GPU and a successive hotplugging of a second display associated with a second GPU. Such unplugging and replugging may successfully configure hardware-accelerated applications to begin using the second GPU after the switch, but may also require the applications to discard data on the first GPU and regenerate the data on the second GPU. Furthermore, the switch may produce a noticeable flicker if the second GPU begins driving the display before the applications fully respond to the switch.

Hence, what is needed is a mechanism for facilitating efficient switching between GPUs without the above-described problems.

### SUMMARY

The disclosed embodiments provide a system that configures a computer system to switch between two graphics-processing units (GPUs). During operation, the system receives a request to switch from using a first GPU to using a second GPU to drive the display. In response to this request, the system executes a first thread that copies pixel values from a first framebuffer for the first GPU to a second framebuffer for the second GPU. Next, the first thread initiates a switch from the first framebuffer to the second framebuffer as a signal source for driving the display. Finally, the first thread sends an asynchronous notification of the switch to one or more applications, wherein the asynchronous notification allows the applications to transition from rendering graphics using the first GPU to rendering graphics using the second GPU.

In some embodiments, the system also executes a second thread to configure the second GPU in preparation for driving the display. After the applications have transitioned from rendering graphics using the first GPU to rendering graphics using the second GPU, the second thread tears down a configuration for the first GPU.

In some embodiments, the first thread executes a window manager that performs operations associated with servicing user requests. Prior to copying pixel values from the first framebuffer to the second framebuffer, the window manager blocks direct writes to the first framebuffer. After the switch from the first framebuffer to the second framebuffer is complete, the window manager composites framebuffer updates from the blocked direct writes and the applications into the second framebuffer.

In some embodiments, if a framebuffer update for an application is on a first video memory for the first GPU, the window manager copies the framebuffer update from the first video memory to system memory on the computer system. The window manager then uploads the framebuffer update from the system memory to a second video memory for the second GPU.

In some embodiments, the first GPU is a low-power GPU which is integrated into a processor chipset, and the second GPU is a high-power GPU which resides on a discrete GPU chip.

In some embodiments, the request is associated with a dependency on the second GPU.

In some embodiments, the first GPU is a general-purpose processor running graphics code, and the second GPU is a special-purpose GPU.

### BRIEF DESCRIPTION OF THE FIGURES

FIG. 1 illustrates a computer system which can switch between different graphics sources to drive the same display in accordance with the disclosed embodiments.

FIG. 2 illustrates the structure of a graphics multiplexer in accordance with the disclosed embodiments.

FIG. 3 shows a timeline of operations involved in switching between graphics-processing units (GPUs) in a computer system in accordance with an embodiment.

FIG. 4 shows a flowchart illustrating the process of configuring a computer system in accordance with an embodiment.

FIG. 5 shows a flowchart illustrating the process of executing a window manager in accordance with an embodiment.

FIG. 6 shows a flowchart illustrating the process of switching from using a first GPU to using a second GPU to drive a display in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for switching between multiple graphics-processing units (GPUs) in a computer system. The computer system may correspond to a laptop computer, personal computer, workstation, and/or portable electronic device containing an embedded GPU and a discrete GPU. Alternatively, the computer system may correspond to an electronic device containing a general-purpose processor (e.g., central processing unit (CPU)) and a special-purpose GPU. The embedded GPU may consume less power than the discrete GPU, while the discrete GPU may provide better graphics performance than the embedded GPU. As a result, the rendering and display of graphics in the computer system may involve a tradeoff between performance and power savings.

More specifically, the disclosed embodiments provide a method and system for atomically switching between GPUs in the computer system. An atomic switch from a first GPU to a second GPU may be carried out by copying pixel values from a first framebuffer for the first GPU to a second framebuffer for the second GPU, then initiating a switch from the first framebuffer to the second framebuffer as the signal source for driving a display in the computer system. Finally, an asynchronous notification of the switch is sent to applications in the computer system.

Such atomic switching and notification may reduce overhead and flicker associated with conventional GPU-switching mechanisms that are implemented as the unplugging of one GPU followed by the hotplugging of another GPU. For example, the asynchronous notification may allow the applications to individually transition from rendering graphics using the first GPU to rendering graphics using the second GPU without losing data stored on video memory of the first GPU. At the same time, the copying of a last known good frame from the first framebuffer to the second framebuffer may prevent flicker in the display as the switch is made.

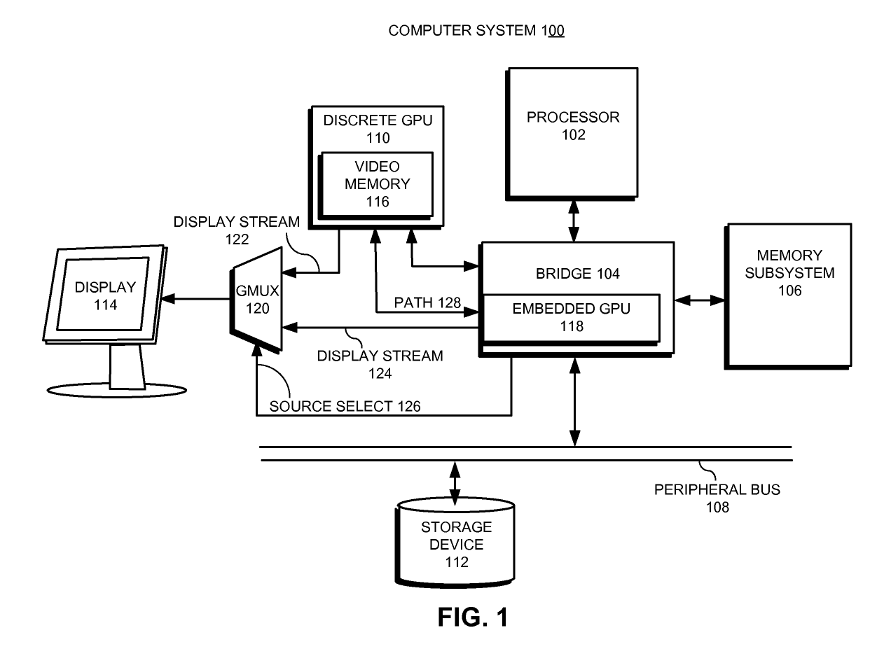

FIG. 1 illustrates a computer system 100 in accordance with the disclosed embodiments. Computer system 100 may correspond to a personal computer, laptop computer, portable electronic device, workstation, and/or other electronic device that can switch between two graphics sources to drive a display. Referring to FIG. 1, the two graphics sources include (1) a discrete GPU 110 and (2) an embedded GPU 118, which can each independently drive display 114. The graphics source driving display 114 is determined by GPU multiplexer (GMUX) 120, which selects between GPU 110 and GPU 118. Hence, computer system 100 may use GMUX 120 to select a graphics source based on current operating conditions.

During operation, display stream 122 from discrete GPU 110 and display stream 124 from embedded GPU 118 both feed into data inputs of GMUX 120. Source select signal 126 feeds into a select input of GMUX 120 and determines which one of the two graphics sources will drive display 114. In the illustrated embodiment, source select signal 126 is produced by bridge chip 104, which includes specific logic for generating source select signal 126. (Note that source select signal 126 can also be produced by a logic block other than bridge chip 104.) The display stream from the selected graphics source then feeds into display 114.

In one embodiment, discrete GPU 110 and embedded GPU 118 communicate through data path 128 to synchronize their display streams. Note that synchronizing the display streams involves synchronizing both the respective timing signals and the respective data signals.

In one embodiment, discrete GPU 110 is a high-performance GPU that consumes a significant amount of power, whereas embedded GPU 118 is a lower-performance GPU that consumes a smaller amount of power. In this embodiment, when the graphics-processing load is light, the system switches from using discrete GPU 110 to using embedded GPU 118 to drive display 114, and subsequently powers down discrete GPU 110, thereby saving power. On the other hand, when the graphics-processing load becomes heavy again, the system switches graphics sources from embedded GPU 118 back to discrete GPU 110. For example, the system may switch from embedded GPU 118 to discrete GPU 110 if a display with a higher resolution than display 114 is plugged into computer system 100.

Although we have described a system that includes a discrete GPU and an embedded GPU, the disclosed technique can generally work in any computer system comprising two or more GPUs, each of which may independently drive display 114. Moreover, GPUs in the same computer system may have different operating characteristics and power-consumption levels. For example, the computer system may switch between a general-purpose processor 102 (e.g., central processing unit (CPU)) and a special-purpose GPU (e.g., discrete GPU 110) to drive display 114. Hence, the disclosed technique is not limited to the specific embodiment illustrated in FIG. 1.

Also note that the above-described process for switching between graphics sources does not involve shutting down or reinitializing the computer system. As a result, the switching process can take substantially less time than it would have if a reinitialization had been required. Consequently, the disclosed technique facilitates rapid and frequent switching between the graphics sources.

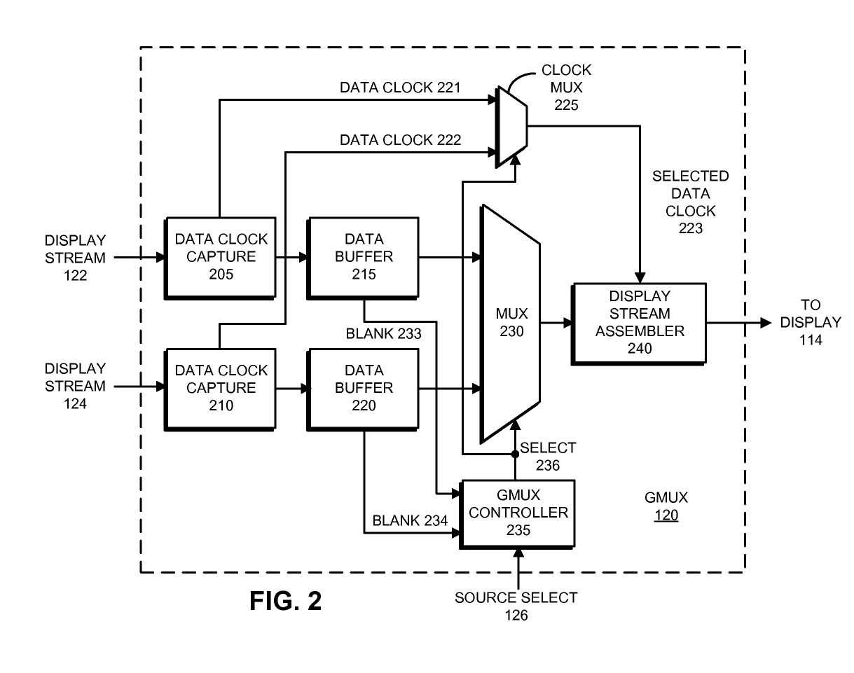

FIG. 2 illustrates the internal structure of the graphics multiplexer 120 (described above with reference to FIG. 1) in accordance with the disclosed embodiments. Referring to FIG. 2, display stream 122 from discrete GPU 110 and display stream 124 from embedded GPU 118 feed into data clock capture blocks 205 and 210, respectively. Data clock capture blocks 205 and 210 de-serialize display streams 122 and 124 and also extract respective data clock signals 221 and 222.

These data clock signals 221 and 222 feed into clock MUX 225, which selects one of data clock signals 221 and 222 to be forwarded to display stream assembler 240. In one embodiment, GMUX controller 235 provides select signal 236 to clock MUX 225. Alternatively, select signal 236 can be provided by other sources, such as processor 102 or another controller.

Next, display streams 122 and 124, with data clocks separated, feed into data buffers 215 and 220, respectively. Data buffers 215 and 220 examine display streams 122 and 124 to determine when blanking intervals occur, and produce respective blanking interval signals 233 and 234. Data buffers 215 and 220 also produce output data streams that feed into data MUX 230.

Blanking interval signals 233 and 234 feed into GMUX controller 235, which compares blanking intervals 233 and 234 to determine how much overlap, if any, exists between the blanking intervals of display streams 122 and 124. (Note that blanking interval signals 233 and 234 can indicate vertical or horizontal blanking intervals.) If GMUX controller 235 determines that blanking intervals 233 and 234 have a sufficient amount of overlap, GMUX controller 235 asserts select signal 236 as the blanking intervals begin to overlap. This causes clock MUX 225 and data MUX 230 to switch between display streams 122 and 124 during the period when their blanking intervals overlap. Because the switching occurs during the blanking intervals, the switching process will not be visible on display 114.

Finally, the output of data MUX 230 and the selected data clock 223 feed into display stream assembler 240, which re-serializes the data stream before sending the data stream to display 114.

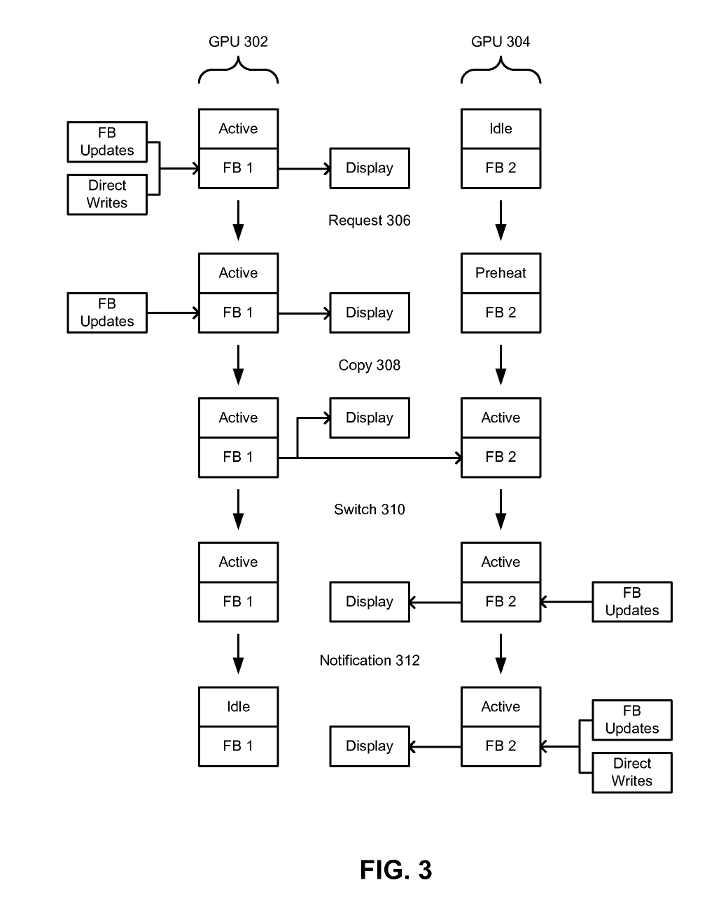

FIG. 3 shows a timeline of operations involved in switching between graphics-processing units (GPUs) in a computer system (e.g., computer system 100 of FIG. 1) in accordance with an embodiment. More specifically, FIG. 3 shows a sequence of operations associated with two GPUs 302-304. The operations may enable an atomic switch from using a first GPU 302 to using a second GPU 304 to drive a display (e.g., display 114 of FIG. 1).

Initially, GPU 302 is active and GPU 304 is idle. In addition, a first framebuffer (e.g., “FB 1”) for GPU 302 is used to drive the display, while a second framebuffer (e.g., “FB 2”) for GPU 304 is not connected to the display. For example, data in the first framebuffer may be pulled by a pipe at the refresh rate of the display and sent to the display to modify the graphical output of the display.

As shown in FIG. 3, frames in the first framebuffer may, at first, include data from both framebuffer updates (e.g., “FB Updates”) and direct writes to the first framebuffer. In one or more embodiments, a window manager obtains framebuffer updates from update buffers for applications on the computer system and composites the framebuffer updates into the first framebuffer. In other words, the window manager may correspond to a compositing window manager that mediates graphical output to the display by the applications. On the other hand, applications with unoccluded windows may bypass the window manager and make direct writes to the first framebuffer (e.g., through an operating system kernel for the computer system). Hence, in subsequent discussions in this disclosure when an application is described as rendering into a frame buffer, this rendering is meant to encompass both: (1) the direct case, wherein an application with an unoccluded window directly writes into a frame buffer; and (2) the indirect case, wherein an application with a potentially occluded window first renders updates to an off-screen buffer and then the updates from the off-screen buffer are composited into the frame buffer.

For example, the display may include a video playing in an unoccluded window and two partially occluded windows for a web browser. To drive the display, the window manager may composite framebuffer updates from update buffers for the web browser with pixel values for a desktop environment and write the composited pixel values to the first framebuffer, while a video player may separately make direct writes of video frames to the portion of the first framebuffer corresponding to the unoccluded window.

Next, a request 306 to switch from GPU 302 to GPU 304 in driving the display is received. Request 306 may be associated with a dependency on GPU 304 that is handled using a policy related to graphical performance and/or power savings in the computer system. For example, the policy may specify a switch from an integrated GPU to a discrete GPU if request 306 corresponds to an explicit user and/or application request (e.g., to the window manager) to switch to the discrete GPU, use of a graphics library such as OpenGL (OpenGL™ is a registered trademark of Silicon Graphics, Inc.), the plugging of a display into the computer system, and/or high-resolution video playback. Conversely, the policy may trigger a switch back to the integrated GPU if all dependencies on the discrete GPU have been removed (e.g., after all applications discontinue use of the graphics library and/or request use of the integrated GPU).

In one or more embodiments, request 306 is received by a kernel thread from the operating system kernel and passed to the window manager by the kernel thread. In response to request 306, the kernel thread may “preheat” GPU 304 in preparation for driving the display. More specifically, the kernel thread may perform hardware-configuration operations that include powering up GPU 304, reinitializing drivers for GPU 304, determining characteristics of the display, and/or copying configuration information (e.g., mode settings, color lookup table (CLUT), etc.) from GPU 302 to GPU 304.

At the same time, the window manager may begin processing request 306 by blocking direct writes to the first framebuffer. To block the direct writes, the window manager may reconfigure the direct writes as framebuffer updates that are composited by the window manager before being written to the first framebuffer. For example, the window manager may prevent direct writes to the first framebuffer by occluding all windows in the display with an invisible window that spans the entirety of the display. Such blocking may provide the window manager with complete control of updates to the first framebuffer, and in turn, the display.

Furthermore, configuration of GPU 304 by the kernel thread and control of updates to the first framebuffer by the window manager may allow the kernel thread and window manager to perform an atomic switch from GPU 302 to GPU 304. In particular, the blocking of direct writes to the first framebuffer may allow the window manager to ensure that the first framebuffer contains a last known good frame before the window manager makes a copy 308 of pixel values from the first framebuffer to the second framebuffer. For example, after the kernel thread notifies the window manager that configuration (e.g., “preheat”) of GPU 304 is complete, the window manager may generate a last known good frame using GPU 302, write the frame to the first framebuffer, and copy the frame to the second framebuffer.

The window manager may then initiate a switch 310 from the first framebuffer to the second framebuffer as the signal source for driving the display. To initiate switch 310, the window manager may generate an interrupt that directs the kernel thread to begin scanning out of the second framebuffer to the display. The kernel thread may then perform a number of synchronization operations to carry out switch 310, including the synchronizing of blanking intervals described above with respect to FIG. 2.

After the kernel thread completes switch 310, the kernel thread may notify the window manager, and the window manager may begin generating new content for the display by compositing framebuffer updates from the blocked direct writes and the applications into the second framebuffer. The window manager may then send an asynchronous notification 312 of the switch to the applications.

In one or more embodiments, notification 312 allows the applications to transition from rendering graphics using GPU 302 to rendering graphics using GPU 304. In other words, switch 310 may not force the applications to start using GPU 304, but instead, may allow the applications to individually finish executing on GPU 302 and transition to using GPU 304 without losing data stored on video memory of GPU 302.

As the applications transition from GPU 302 to GPU 304, the window manager may obtain and composite framebuffer updates from both GPUs into graphical output for the display. More specifically, if a framebuffer update for an application is on video memory of GPU 302 (e.g., if the application is still using GPU 302), the window manager may copy the framebuffer update from the video memory of GPU 302 to system memory on the computer system. The window manager may then upload the framebuffer update from the system memory to video memory for the second GPU 304. (Note that the above-described transfer of a frame buffer update from the video memory of GPU 302 to the video memory of GPU 304 can alternatively bypass the system memory.)

The window manager may continue compositing framebuffer updates from both framebuffers as long as both GPU 302 and GPU 304 are used by the applications. To facilitate efficient processing of graphical output, the window manager may also allow direct writes of pixel values for unoccluded windows to the second framebuffer from applications that have transitioned to GPU 304. Finally, after all applications have transitioned to GPU 304, the kernel thread may tear down a configuration for GPU 302. In particular, the kernel thread may remove application-visible data structures containing state information associated with GPU 302 and/or driver state associated with GPU 302. The kernel thread may then complete the switch from GPU 302 to GPU 304 by putting GPU 302 in an idle state (e.g., removing power from GPU 302).

Because the switch from GPU 302 to GPU 304 does not erase state information from GPU 302 and/or force applications to move to GPU 304, the applications may complete processing on GPU 302 before transitioning to GPU 304. Such asynchronous transitioning may represent a reduction in overhead from mechanisms that synchronously perform GPU switches by unplugging one GPU and subsequently hotplugging another GPU.

Moreover, direct writes can be suspended during the transition to prevent flicker associated with writing incomplete frame buffer updates to the second frame buffer during the switch. More specifically, suspending direct writes during the switch allows a last know good frame to be established in the first frame buffer. This last known good frame can then be copied to the second frame buffer and direct writes can be unsuspended to complete the transition without encountering problems with flickering problems caused by writing incomplete frame buffer updates.

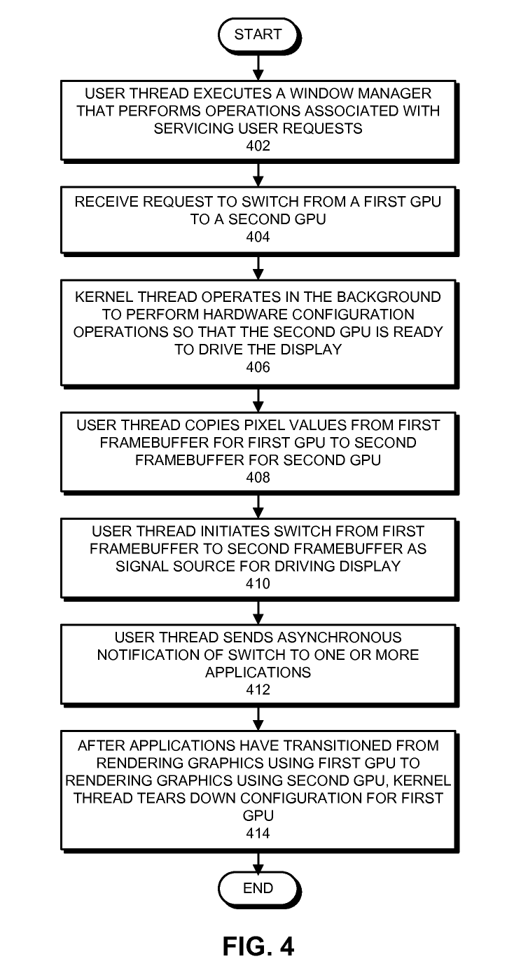

FIG. 4 shows a flowchart illustrating the process of configuring a computer system in accordance with an embodiment. In one or more embodiments, one or more of the steps may be omitted, repeated, and/or performed in a different order. Accordingly, the specific arrangement of steps shown in FIG. 4 should not be construed as limiting the scope of the embodiments.

First, a user thread executes a window manager that performs operations associated with servicing user requests (operation 402). In particular, one of the user requests may be received as a request to switch from using a first GPU to using a second GPU to drive the display (operation 404). The first GPU may correspond to a low-power and/or low-performance GPU, such as a general-purpose processor executing graphics code and/or an integrated GPU. The second GPU may be associated with higher performance and power consumption than the first GPU. For example, the second GPU may correspond to a discrete GPU if the first GPU is an integrated GPU, or the second GPU may correspond to a special-purpose GPU if the first GPU is a CPU. As a result, the request may be associated with a dependency on the graphics-processing capabilities of the second GPU.

In response to the event, a kernel thread operates in the background to perform hardware-configuration operations for the second GPU to ensure that the second GPU is ready to drive the display (operation 406). The hardware-configuration operations may include powering up the second GPU, reinitializing drivers for the second GPU, determining characteristics of the display, and/or copying configuration information from the first GPU to the second GPU.

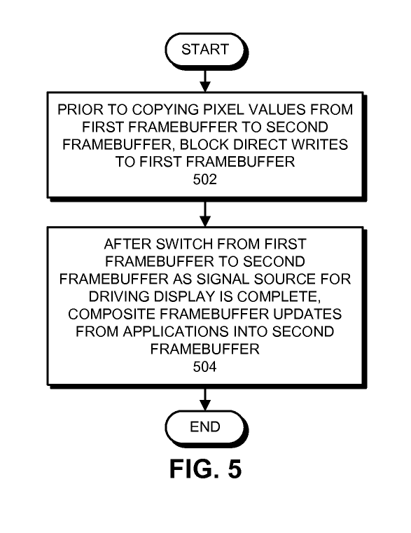

The user thread then copies pixel values from a first framebuffer for the first GPU to a second framebuffer for the second GPU (operation 408). As discussed below with respect to FIG. 5, the user thread may also ensure that the pixel values correspond to a last known good frame before copying the pixel values. The user thread also initiates a switch from the first framebuffer to the second framebuffer as the signal source for driving the display (operation 410). For example, the user thread may generate an interrupt that directs the kernel thread to switch from the first framebuffer to the second framebuffer as the signal source.

After the switch is complete, the user thread sends an asynchronous notification of the switch to one or more applications (operation 412). The asynchronous notification may allow the applications to transition from rendering graphics using the first GPU to rendering graphics using the second GPU without forcing the applications to begin using the second GPU.

Finally, after the applications have transitioned from rendering graphics using the first GPU to rendering graphics using the second GPU, the kernel thread tears down a configuration for the first GPU (operation 414). To tear down the configuration for the first GPU, the kernel thread may remove application-visible data structures containing state information associated with the first GPU, driver state associated with the first GPU, and/or power from the first GPU.

FIG. 5 shows a flowchart illustrating the process of executing a window manager in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

Prior to copying pixel values from a first framebuffer for a first GPU to a second framebuffer for a second GPU (e.g., operation 408 of FIG. 4), the window manager blocks direct writes to the first framebuffer (operation 502). For example, the window manager may prevent direct writes to the first framebuffer by “occluding” all windows with an invisible window that spans the entirety of a display. Such blocking may provide the window manager with complete control of updates to the first framebuffer, thus allowing the window manager to ensure that pixel values in the first framebuffer correspond to a last known good frame for the display.

Next, after a switch from the first framebuffer to the second framebuffer as a signal source for driving the display is complete, the window manager composites framebuffer updates from applications into the second framebuffer (operation 504). In addition, the framebuffer updates may be obtained and composited from video memory for both GPUs. For example, the window manager may composite framebuffer updates from both GPUs as long as both GPUs are used by the applications. If a framebuffer update for an application is on a first video memory for the first GPU, the window manager copies the framebuffer update from the first video memory to system memory on a computer system containing the GPUs, then uploads the framebuffer update from the system memory to a second video memory for the second GPU.

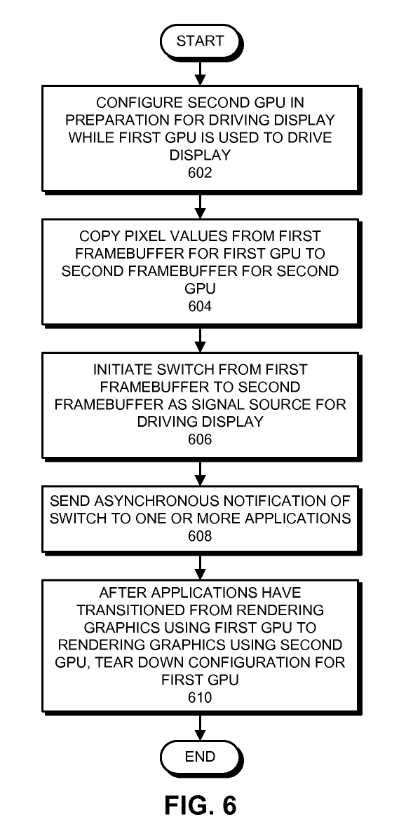

FIG. 6 shows a flowchart illustrating the process of switching from using a first graphics-processing unit (GPU) to using a second GPU to drive a display in accordance with an embodiment. In one or more embodiments, one or more of the steps may be omitted, repeated, and/or performed in a different order. Accordingly, the specific arrangement of steps shown in FIG. 6 should not be construed as limiting the scope of the embodiments.

First, a second GPU is configured in preparation for driving the display while the first GPU is used to drive the display (operation 602). The second GPU may be configured by a kernel thread. Next, pixel values from a first framebuffer for the first GPU are copied to a second framebuffer for the second GPU (operation 604), and a switch from the first framebuffer to the second framebuffer as the signal source for driving the display is initiated (operation 606).

An asynchronous notification of the switch is then sent to one or more applications (operation 608). The asynchronous notification may allow the applications to transition from rendering graphics using the first GPU to rendering graphics using the second GPU. Finally, after the applications have transitioned from rendering graphics using the first GPU to rendering graphics using the second GPU, a configuration for the first GPU torn down (operation 610) to complete the switch.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for configuring a computer system, comprising:
using a first thread to execute a window manager that performs operations associated with servicing user requests;
receiving, at the first thread, a request to switch from using a first graphics-processing unit (GPU) to using a second GPU to drive a display; and
in response to the request, using the first thread to:
copy pixel values from a first framebuffer for the first GPU to a second framebuffer for the second GPU;
initiate a switch from the first framebuffer to the second framebuffer as a signal source for driving the display; and
send an asynchronous notification of the switch to one or more applications, wherein the asynchronous notification allows the applications to transition from rendering graphics using the first GPU to rendering graphics using the second GPU.

2. The method of claim 1, wherein in response to the request, the method further comprises:
using a second thread to configure the second GPU in preparation for driving the display; and
after the applications have transitioned from rendering graphics using the first GPU to rendering graphics using the second GPU, using the second thread to tear down a configuration for the first GPU.

3. The method of claim 1, wherein using the first thread to execute the window manager involves:
prior to copying pixel values from the first framebuffer to the second framebuffer, blocking direct writes to the first framebuffer.

4. The method of claim 3, wherein using the first thread to execute the window manager further involves:
after the switch from the first framebuffer to the second framebuffer is complete, compositing framebuffer updates from the blocked direct writes and the applications into the second framebuffer.

5. The method of claim 4, wherein compositing framebuffer updates from the applications into the second framebuffer involves:
if a framebuffer update for an application is on a first video memory for the first GPU:
copying the framebuffer update from the first video memory to system memory on the computer system; and
uploading the framebuffer update from the system memory to a second video memory for the second GPU.

6. The method of claim 1,
wherein the first GPU is a low-power GPU which is integrated into a processor chipset, and the second GPU is a high-power GPU which resides on a discrete GPU chip.

7. The method of claim 6, wherein the request is associated with a dependency on the second GPU.

8. The method of claim 1, wherein the first GPU is a general-purpose processor running graphics code, and the second GPU is a special-purpose GPU.

9. A computer system that switches from a first graphics processor to a second graphics processor to drive a display, comprising:
system memory;
a display;
a first graphics-processing unit (GPU);
a second GPU;
a graphics multiplexer configured to couple either a first framebuffer for the first GPU or a second framebuffer for the second GPU to the display; and
a switching mechanism configured to switch from using the first GPU to using the second GPU to drive the display by:
copying pixel values from the first framebuffer to the second framebuffer;
initiating a switch from the first framebuffer to the second framebuffer as a signal source for driving the display; and
sending an asynchronous notification of the switch to one or more applications, wherein the asynchronous notification allows the applications to transition from rendering graphics using the first GPU to rendering graphics using the second GPU.

10. The computer system of claim 9, wherein the switching mechanism comprises:
a first thread configured to execute a window manager that performs operations associated with servicing user requests, wherein one of the user requests corresponds to a request to switch from using the first GPU to using the second GPU to drive the display.

11. The computer system of claim 10, wherein the switching mechanism further comprises;
a second thread configured to:
configure the second GPU in preparation for driving the display; and
after the applications have transitioned from rendering graphics using the first GPU to rendering graphics using the second GPU, tear down a configuration for the first GPU.

12. The computer system of claim 10, wherein using the first thread to execute the window manager involves:
prior to copying pixel values from the first framebuffer to the second framebuffer, blocking direct writes to the first framebuffer.

13. The computer system of claim 12, wherein using the first thread to execute the window manager further involves:
after the switch from the first framebuffer to the second framebuffer is complete, compositing framebuffer updates from the blocked direct writes and the applications into the second framebuffer.

14. The computer system of claim 13, wherein compositing framebuffer updates from the applications into the second framebuffer involves:
if a framebuffer update for an application is on a first video memory for the first GPU:
copying the framebuffer update from the first video memory to system memory on the computer system; and
uploading the framebuffer update from the system memory to a second video memory for the second GPU.

15. The computer system of claim 10,
wherein the first GPU is a low-power GPU which is integrated into a processor chipset, and the second GPU is a high-power GPU which resides on a discrete GPU chip.

16. The computer system of claim 15, wherein the request is associated with a dependency on the second GPU.

17. A computer-readable storage medium storing instructions that when executed by a computer cause the computer to perform a method for configuring a computer system, the method comprising:
using a first thread to execute a window manager that performs operations associated with servicing user requests;
receiving, at the first thread, a request to switch from using a first graphics-processing unit (GPU) to using a second GPU to drive a display; and
in response to the request, using the first thread to:
copy pixel values from a first framebuffer for the first GPU to a second framebuffer for the second GPU;
initiate a switch from the first framebuffer to the second framebuffer as a signal source for driving the display; and
send an asynchronous notification of the switch to one or more applications, wherein the asynchronous notification allows the applications to transition from rendering graphics using the first GPU to rendering graphics using the second GPU.

18. The computer-readable storage medium of claim 17, wherein in response to the request, the method further comprises:
using a second thread to configure the second GPU in preparation for driving the display; and
after the applications have transitioned from rendering graphics using the first GPU to rendering graphics using the second GPU, using the second thread to tear down a configuration for the first GPU.

19. The computer-readable storage medium of claim 17, wherein using the first thread to execute the window manager involves:
prior to copying pixel values from the first framebuffer to the second framebuffer, blocking direct writes to the first framebuffer.

20. The computer-readable storage medium of claim 19, wherein using the first thread to execute the window manager further involves:
after the switch from the first framebuffer to the second framebuffer is complete, compositing framebuffer updates from the blocked direct writes and the applications into the second framebuffer.

21. The computer-readable storage medium of claim 20, wherein compositing framebuffer updates from the applications into the second framebuffer involves:
if a framebuffer update for an application is on a first video memory for the first GPU:
copying the framebuffer update from the first video memory to system memory on the computer system; and
uploading the framebuffer update from the system memory to a second video memory for the second GPU.

22. The computer-readable storage medium of claim 17, wherein the first GPU is a low-power GPU which is integrated into a processor chipset, and the second GPU is a high-power GPU which resides on a discrete GPU chip.

23. The computer-readable storage medium of claim 22, wherein the request is associated with a dependency on the second GPU.

24. A method for switching from using a first graphics-processing unit (GPU) to using a second GPU to drive a display, comprising:
copying pixel values from a first framebuffer for the first GPU to a second framebuffer for the second GPU;
initiating a switch from the first framebuffer to the second framebuffer as a signal source for driving the display; and
sending an asynchronous notification of the switch to one or more applications, wherein the asynchronous notification allows the applications to transition from rendering graphics using the first GPU to rendering graphics using the second GPU.

25. The method of claim 24, further comprising:
configuring the second GPU in preparation for driving the display while the first GPU is used to drive the display; and
after the applications have transitioned from rendering graphics using the first GPU to rendering graphics using the second GPU, tearing down a configuration for the first GPU.
